(19) United States
(12) Patent Application Publication
(10) Pub. No.: US 2024/0198526 A1
(43) Pub. Date: Jun. 20, 2024

(54) AUTO-GENERATION OF PATH CONSTRAINTS FOR GRASP STABILITY

(71) Applicant: Siemens Aktiengesellschaft, Munich (DE)

(72) Inventors: Juan L. Aparicio Ojea, Moraga, CA (US); Heiko Claussen, Wayland, MA (US); Ines Ugalde Diaz, Redwood City, CA (US); Gokul Narayanan Sathya Narayanan, Emeryville, CA (US); Eugen Solowjow, Berkeley, CA (US); Chengtao Wen, Redwood City, CA (US); Wei Xi Xia, Daly City, CA (US); Yash Shahapurkar, Berkeley, CA (US); Shashank Tamaskar, Mohali, Punjab (IN)

(73) Assignee: Siemens Aktiengesellschaft, Munich (DE)

(21) Appl. No.: 18/555,767

(22) PCT Filed: May 25, 2021
(86) PCT No.: PCT/US2021/034035

§ 371 Date: Oct. 17, 2023

(51) Int. Cl. B25J 9/16

(52) U.S. Cl. CPC B25J 9/1669; B25J 9/1651; B25J 9/1664

(57) ABSTRACT

In some cases, grasp point algorithms can be implemented so as to compute grasp points on an object that enable a stable grasp. It is recognized herein, however, that in practice a robot in motion can drop the object or otherwise have grasp issues when the object is grasped at the computed stable grasp points. Path constraints that can differ based on a given object are generated while generating the trajectory for a robot, so as to ensure that a grasp remains stable throughout the motion of the robot.

### BACKGROUND

Artificial Intelligence (AI) and robotics are a powerful combination for automating tasks inside and outside of the factory setting. Autonomous operations in dynamic environments may be applied to mass customization (e.g., high-mix, low-volume manufacturing), on-demand flexible manufacturing processes in smart factories, warehouse automation in smart stores, automated deliveries from distribution centers in smart logistics, and the like. For example, industrial manipulators or robots are widely used in bin-picking and material handling applications that require grasping a variety of loads and objects. Such robots often require expert knowledge to implement grasping for individual use cases, which can be time-consuming and costly.

In some cases, grasp point algorithms can be implemented so as to compute grasp points on an object that enable a stable grasp. It is recognized herein, however, that in practice a robot in motion can drop the object or otherwise have grasp issues when the object is grasped at the computed stable grasp points.

### BRIEF SUMMARY

Embodiments of the invention address and overcome one or more of the described-herein shortcomings or technical problems by providing methods, systems, and apparatuses for addressing grasp stability issues associated with a robot's motion. In particular, constraints that can differ based on a given object can be generated while generating the trajectory for a robot, so as to ensure that a grasp remains stable throughout the motion of the robot.

In an example aspect, a computing system can retrieve a model of a target object. The model can indicate one or more physical properties of the object. The computing system can further receive robot configuration data associated with a robotic cell in which the object is positioned. Further still, the computing system can obtain grasp point data associated with the object. Based on the robot configuration data, the one or more physical properties of the object, and the grasp point data, the system can select a path constraint for moving the object from a first location to a second location so as to define a selected path constraint. The selected path constraint can define a grasp pose for a particular robot to carry the object, a velocity associated with moving the object in the grasp pose, and an acceleration associated with moving the object in the grasp pose.

### BRIEF DESCRIPTION OF THE SEVERAL VIEWS OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 shows an example system that includes an autonomous machine in an example physical environment that includes various objects, in accordance with an example embodiment.

FIG. 2 illustrates an example computing system configured to determine path constraints for robotic operations, in accordance with an example embodiment.

FIG. 3 illustrates another example computing system configured to determine path constraints for robotic operations, in accordance with another example embodiment

FIG. 4 illustrates a computing environment within which embodiments of the disclosure may be implemented.

### DETAILED DESCRIPTION

It is recognized herein that even after grasping an object at a stable grasp point, the object can fall from an end-effector of the robot due to the robot's motion involved in moving the object. By way of example, objects grasped with a vacuum gripper, among other grippers, can fall due to the object's pose, velocity, and/or acceleration. It is recognized herein that current approaches to designing systems that can safely transport objects often involve a robot programmer designing constraints separately for individual objects on a trial-and-error basis. In other approaches, end-to-end reinforcement learning is used. It is further recognized herein that such existing approaches cannot address complex tasks and/or are unduly time consuming. Embodiments described herein can automatically generate path constraints (e.g., pose, velocity, acceleration) associated with robot motion, so as to enable safe and efficient transportation of various objects between various points.

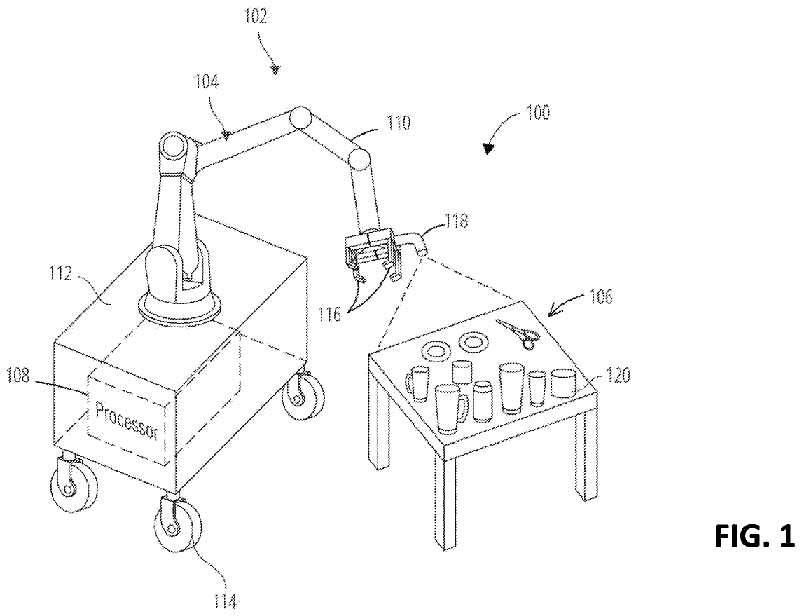

Referring now to FIG. 1, an example industrial or physical environment 100 is shown. As used herein, a physical environment can refer to any unknown or dynamic industrial environment. A reconstruction or model may define a virtual representation of the physical environment 100 or one or more objects 106 within the physical environment 100. The physical environment 100 can include a computerized autonomous system 102 configured to perform one or more manufacturing operations, such as assembly, transport, or the like. The autonomous system 102 can include one or more robot devices or autonomous machines, for instance an autonomous machine or robot device 104, configured to perform one or more industrial tasks, such as bin picking, grasping, or the like. The system 102 can include one or more computing processors configured to process information and control operations of the system 102, in particular the autonomous machine 104. The autonomous machine 104 can include one or more processors, for instance a processor 108, configured to process information and/or control various operations associated with the autonomous machine 104. An autonomous system for operating an autonomous machine within a physical environment can further include a memory for storing modules. The processors can further be configured to execute the modules so as to process information and generate models based on the information. It will be understood that the illustrated environment 100 and the system 102 are simplified for purposes of example. The environment 100 and the system 102 may vary as desired, and all such systems and environments are contemplated as being within the scope of this disclosure.

Still referring to FIG. 1, the autonomous machine 104 can further include a robotic arm or manipulator 110 and a base 112 configured to support the robotic manipulator 110. The base 112 can include wheels 114 or can otherwise be configured to move within the physical environment 100. The autonomous machine 104 can further include an end effector 116 attached to the robotic manipulator 110. The end effector 116 can include one or more tools configured to grasp and/or move objects 106. Example end effectors 116 include finger grippers or vacuum-based grippers. The robotic manipulator 110 can be configured to move so as to change the position of the end effector 116, for example, so as to place or move objects 106 within the physical environment 100. The system 102 can further include one or more cameras or sensors, for instance a three-dimensional (3D) point cloud camera 118, configured to detect or record objects 106 within the physical environment 100. The camera 118 can be mounted to the robotic manipulator 110 or otherwise mounted within the physical environment 100 so as to be to generate a 3D point cloud of a given scene, for instance the physical environment 100. Alternatively, or additionally, the one or more cameras of the system 102 can include one or more standard two-dimensional (2D) cameras that can record or capture images (e.g., RGB images or depth images) from different viewpoints. Those images can be used to construct 3D images. For example, a 2D camera can be mounted to the robotic manipulator 110 so as to capture images from perspectives along a given trajectory defined by the manipulator 110.

With continuing reference to FIG. 1, in an example, one or more cameras can be positioned over the autonomous machine 104, or can otherwise be disposed so as to continuously monitor any objects within the environment 100. For example, when an object, for instance one of the objects 106, is disposed or moved within the environment 100, the camera 118 can detect the object. In an example, the processor 108 can determine whether a given object that is detected is recognized by the autonomous system 102, so as to determine whether an object is classified as known or unknown (new).

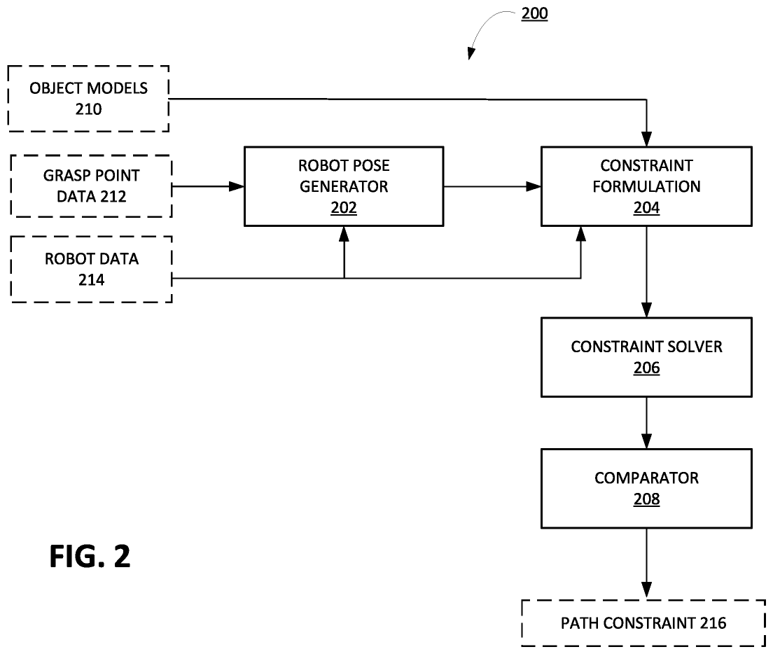

Referring now to FIG. 2, in accordance with various embodiments, a computing system 200 can be configured to determine path constraints, so as to define paths for robots grasping objects in various manufacturing or industrial applications. The computing system 200 can include one or more processors and memory having stored thereon applications, agents, and computer program modules including, for example, a robot pose generator 202, a constraint formulation module 204, a constraint optimization solver 206, and a comparator module 208. It will be appreciated that the program modules, applications, computer-executable instructions, code, or the like depicted in FIG. 2 are merely illustrative and not exhaustive, and that processing described as being supported by any particular module may alternatively be distributed across multiple modules or performed by a different module. In addition, various program module(s), script(s), plug-in(s), Application Programming Interface(s) (API(s)), or any other suitable computer-executable code may be provided to support functionality provided by the program modules, applications, or computer-executable code depicted in FIG. 2 and/or additional or alternate functionality. Further, functionality may be modularized differently such that processing described as being supported collectively by the collection of program modules depicted in FIG. 2 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 2 may be implemented, at least partially, in hardware and/or firmware across any number of devices.

With continuing reference to FIG. 2, the computing system 200 can store, or can otherwise obtain, various data that the computing system 200 can use to generate various path constraints associated with robot motion. For example, the computing system 200 can be communicatively coupled to a database that stores data for generating path constraints. Additionally, or alternatively, the computing system 200 can define one or more robotic cells from which data is obtained. A robotic cell can refer to the physical environment or system in which one or more robots operate. By way of example, the autonomous system 102 can define a robotic cell that is communicatively coupled to, or is part of, the computing system 200. The data can include, for example, object models 210, grasp point data 212, and robot configuration data 214.

The robot configuration data 214 can identify particular robots that are available in a particular robotic cell or autonomous system. The robot configuration data 214 can further indicate grasping modalities or end effector types (e.g., vacuum suction, finger pinch) associated with robots that are available in a particular cell or system. Further still, the robot configuration data 214 can indicate various specifications associated with respective robots, such as position, velocity, and acceleration limits. Such limits can collectively be referred to as joint limits, and generally refer to maximum values associated with a robot. The joint limits can be defined by the manufacturer of a given robot, and can be obtained from the robot's specification. In particular, by way of example and without limitation, a given specification may define a robot's maximum velocity, acceleration, and various positional tolerances, such as suction strengths or grasp widths. Another joint limit that can be defined by the manufacturer or otherwise provided in the robot configuration data 214 is a torque limit. A torque limit refers to a maximum rotational force that a given joint can take. Similarly, a jerk limit can be calculated in some cases from the robot configuration data. A jerk limit can refer to limits associated with jerks, or sudden accelerations, of joints. Additionally, or alternatively, the robot configuration data 214 can include the position of the robots within the robotic cell, payloads of the robots (e.g., maximum weight that a robot can carry), and an indication of the types of grippers or tool changers that a given robot can carry. The robot configuration data 214 can also include various models associated with the robots within a given robotic cell. Such models can include, for example and without limitation, collision models of a robot or kinematics models of a robot. By way of example, collision models can define a CAD model of a robotic arm, for instance the manipulator 110, which can be used to determine if the robot collides with other objects or equipment within the robotic cell. Kinematics models can be used to translate robot poses from joint space to cartesian space, and visa-versa.

The grasp point data 212 can include one or more positional coordinates associated with grasping a particular object with a particular end effector. Thus, the grasp point data for a particular object can vary based on the type of end effector of a robot. Historical grasp points can be stored in a database accessible by the robot pose generator 202 for future use. Additionally, or alternatively, grasp point data 212 for a particular object be generated by a grasp neural network that is trained on various other objects. The object models 210 can include one or more models, for instance computer-aided design (CAD) models, of an object that is targeted for grasping and moving. From the respective object model 210, the system 200 can extract or obtain various properties of the object represented by the respective model 210. For example, the system 200 can extract mass distribution and various dimensions of the object. By way of further example, the system 200 can use the models 210 to determine the material composition of the object such as surface texture or porosity.

With continuing reference to FIG. 2, a given robotic cell or autonomous system can be equipped with a variety of robotic arms and grippers. Information associated with such robotic arms and grippers can be included in the robot configuration data 214. The robot configuration data 214 can be sent to the robot pose generator 202 and the constraint formulation module 204, for example, when a pick and place operation is triggered. In some cases, the robot configuration data 214 that is obtained is based on the particular robotic cell for which path constraints 216 are being generated. For example, the robot configuration data 214 can be stored in a database, and identified based on its associated robotic cell(s). In particular, the robot pose generator 202 can obtain the end effector type (e.g., vacuum, finger gripper, etc.) of a given robot. Similarly, the robot pose generator 202 can retrieve the grasp point data 212, which can include grasp points for the object involved in the operation, for instance a pick and place operation. Based on the grasp points associated with the target object and the end effector type associated with the robot involved in the operation, the robot pose generator 202 can determine robot poses related to grasping the object. Robot poses for grasping the object can define the position and orientation of the end effector 116 when the robot grasps and moves the target object. In some examples, the position values of the end effector are directly calculated based on the grasp point data 212 by way of linear relation. For example, in order to generate the orientation of the end effector, the robot pose generator 202 can leverage a sampling-based approach. In particular, in an example, the robot pose generator 202 can sample multiple end-effector orientations while rejecting the ones which are invalid. Orientations can be invalid because of collisions and/or singularity, among other reasons. Continuing with the example, because the robot pose generator 202 can implement a sample-based approach, in some cases, the minimum number of required poses can be defined initially as a system parameter. The output from the robot pose generator 202 can include a list of robot poses in a 6D (e.g., position and orientation) coordinate system.

Based on the object that is involved in the robotic operation (target object), object models 210 that represent the object can be retrieved by the constraint formulation module 204. Such object models 210 can indicate various physical properties of the target object, such as mass, geometric size dimensions, weight distribution, material of the object, and the like. Furthermore, based on the robot that is involved in the operation, robot configuration data 214 associated with the robot can be retrieved by the constraint formulation module 204. The robot configuration data 214 that is retrieved can include limits of the robot, such as a maximum position, velocity, acceleration, and torque of the joints of the robot. The limits can further include jerk limits related to the joints of the robot. Additionally, or alternatively, the type of end effector and its specifications can be obtained or retrieved from the robot configuration data 214. By way of example, and without limitation, values that can be obtained or determined from the robot configuration data 214 are presented here to illustrate one example: Maximum Joint Position=+/−3.14 rad; Maximum Joint Velocity=+/−1.5 rad/sec; Maximum Joint Acceleration=+/−1.0 rad/sec²; Maximum Joint Jerk=+/−0.8 rad/sec³; Maximum Joint torque=20 N/m; End Effector Type=Suction; Maximum Suction Feed Pressure=5 bar.

Continuing with the example, based on the robot poses generated by the robot pose generator 202, the physical properties of the target object, and the joint limits of the robot involved in the operation, the constraint formulation module 204 can generate a constraint optimization problem. In particular, the constraint formulation module 204 can generate an objective function and a constraint equation, which can be provided to the constraint optimization solver 206. To illustrate by way of example, and without limitation, example constraints can include: End effector Velocity Constraint ‘X1’=−2.1<X1<2.1, End Effector Acceleration Constraint ‘X2’=−1.5<X2<1.5, Force Constraint ‘X3’=0<X3<7; and an example objective function can define a polynomial equation containing the variables (X1, X2, X3.

Using the constraints and the objective function generated by the constraint formulation module 204, the constrain optimization solver 206 can solve the objective function so as to maximize the velocity and acceleration of the end effector for each grasp pose, while ensuring that the force, inertia, and joint limits are within their respective constraints. Thus, the constraint optimization solver 206 can generate velocity and acceleration values that define the maximum speeds and accelerations at which the end-effector can operate while maintaining a stable grasp on the target object throughout the robot motion. The constraint optimization solver 206 can generate maximum velocity and acceleration values for each of the robot poses associated with each of the grasp points (grasp poses). Thus, the constraint optimization solver 206 can provide a plurality of acceleration and velocity value pairs associated with various (for instance all) robot poses to the comparator module 208. The comparator module 208 can compare the velocity and acceleration value pairs generated for different grasp poses and select the best combination, so as to determine the path constraint 216. In some cases, the comparator module 208 selects the pose associated with the maximum velocity and acceleration values. Alternatively, or additionally, the comparator module 208 can base its selection on user-defined specifications. For example, such user-defined specifications can be used to resolve ties or to prioritize certain combinations.

Thus, the path constraint 216 can include constraints on the velocity, acceleration, and pose of the end effector during a robotic operation that involves moving the target object. Based on the path constraint 216, the system 200 can determine a trajectory for operating the robot so as to move the target object. In some cases, the comparator module 208 can send the path constraint 216 to the associated robotic cell in the form of an instruction, so that the selected robot performs the operation, for instance a pick and place operation, in accordance with the path constraint 216.

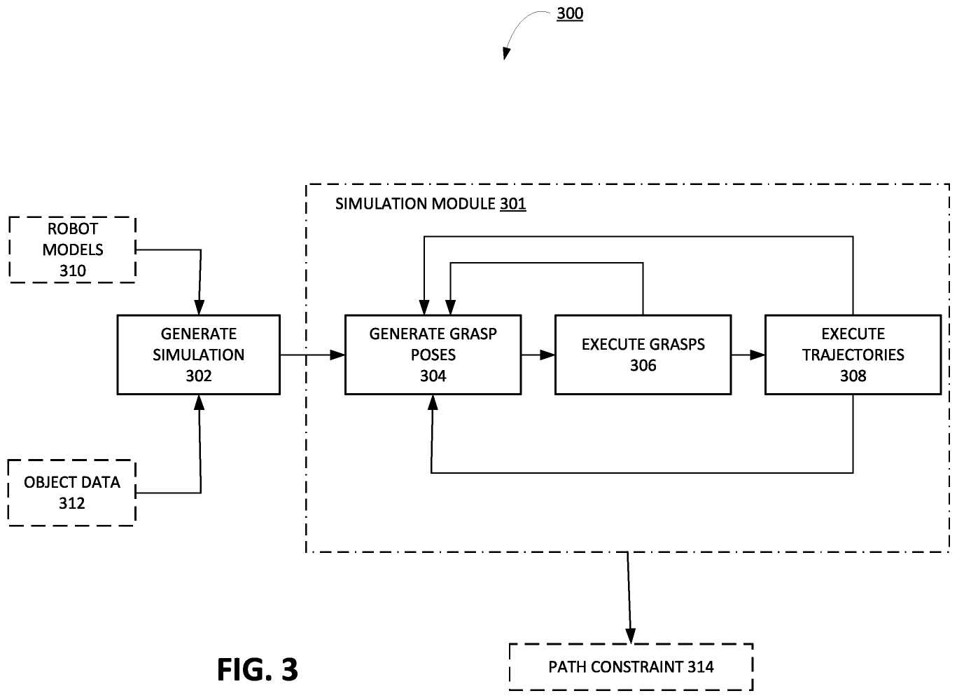

Referring now to FIG. 3, in accordance with another embodiment, a computing system 300 can be configured to determine path constraints 314, so as to define paths for robots grasping objects in various manufacturing or industrial applications. The computing system 300 can include one or more processors and memory having stored thereon applications, agents, and computer program modules. The computing system 300 can store, or can otherwise obtain, various data that the computing system 300 can use to generate various path constraints associated with robot motion. For example, the computing system 300 can be communicatively coupled to a database that stores data for generating path constraints. Additionally, or alternatively, the computing system 300 can define one or more robotic cells from which data is obtained. The data can include, for example and without limitation, robot models 310 and object data 312.

The robot models 310 can identify particular robots that are available in a particular robotic cell or autonomous system. The robot models 310 can further indicate grasping modalities or end effector types (e.g., vacuum suction, finger pinch) associated with robots that are available in a particular cell or system. Further still, as described above, the robot models 310 can indicate various specifications associated with respective robots, such as position, velocity, and acceleration limits of the joints of the robot. Such limits can collectively be referred to as joint limits, and generally refer to maximum values associated with robot joints. The object data 312 can define a synthetic object dataset that can include data associated with an object that is targeted for grasping and moving.

With continuing reference to FIG. 3, at 302, based on the robot models 310 and the object data 312, the computing system 200 can generate a simulation environment. In various examples, the simulation environment generated at 302 can define a multi-joint dynamics with contact (MuJoCo) environment or bullet physics-based (PyBullet) environment. The generated simulated environment can look similar to the autonomous system 102, for example. A robot represented by one of the robot models 310 can be spawned in the simulation environment at a predefined 6D coordinate pose. Similarly, a table or other platform that supports objects can be spawned at a predefined 6D coordinate pose. Then, in some cases, one or more objects from the object data 312 can be selected and spawned on the table, at a randomly generated object pose. A simulation module 301 of the computing system 300 can be configured to perform simulations within the simulation environment that is generated. For example, at 304, the simulation module 301 can generate different grasp poses for a given end-effector to grasp the target object. Using the generated grasp poses, at 306, the simulation module 301 can execute each of the generated grasp poses on the target object. If the object is successfully grasped by a given grasp pose, the simulation can proceed to 308, where the given grasp pose is simulated along one or more trajectories. The trajectories can define various velocity and acceleration profiles. If the object is not successfully grasped during the simulation at 304, the simulation can return to 302, where one or more additional grasp poses can be generated.

With continuing reference to FIG. 3, at 310, one or more trajectory simulations are performed. During a trajectory simulation, the simulation module 301 can determine whether the end effector is holding the object after the target object has been grasped and moved along the trajectory. Further, the simulation module 301 can measure a deviation between the grasp pose of the object and the pose of the object after the object has moved along the trajectory to its destination. Furthermore, at 310, the simulation module 301 can award values based on the performance of the trajectory simulation. In various examples, the reward value defines a weighted function of the trajectory parameters such as velocity, acceleration, jerk, object position deviation, and trajectory success state. For example, the simulation module 301 can assign a negative award to a particular trajectory simulation if the object is dropped. In other examples, if the object was successfully transported from its grasp position to its final destination, reward values can vary based on pose deviation and trajectory parameters, such as velocity and acceleration. For example, a first successful trajectory that defines a higher velocity and/or acceleration than the velocity and/or acceleration defined by a second successful trajectory may be assigned a higher reward value that the reward value assigned to the second successful trajectory. In some cases, the reward function can be defined by a user, such that specific path constraints can receive additional weight, or less weight, depending on the particular focus. Based on the reward values, the simulation module 301 can learn various grasp poses and trajectory parameters for various objects.

Additionally, the reward values can be utilized to guide the search space while sampling the values for the path constraints. To illustrate by way of example, consider five different path constraints where all of them have a fixed velocity (e.g., 2.0 m/s) but the acceleration values vary within a range (e.g., 1 m/s² to 3 m/s²). Furthermore, consider the scenario where after executing the simulation, the reward values for the all the above path constraints are calculated to be negative. From this information, the system can infer that the sampled velocity and acceleration space is not good. Based on this learning, the simulation module 301 can automatically change the sampling direction to generate better constraints 314 associated with a particular robot and object. In particular, the path constraints 314 can define the grasp pose and trajectory parameters (velocity and acceleration) for a particular object. Thus, grasp poses and trajectory parameters for the grasp poses can be generated for safe transportation of a target object. The trajectory parameters can define a maximum velocity and a maximum acceleration in which the object can be safely moved in a particular grasp.

Thus, the computing systems 200 and 300 can automatically generate path constraints for a new object, so as to ensure that the object is safely handled and transported. Without being bound by theory, it is recognized herein that existing approaches to trajectory analysis typically rely on determining successful grasp poses, whereas the systems described herein account for various robot motions (e.g., speeds, accelerations) while implement different grasp poses.

As described herein, in accordance with various embodiments, an autonomous system can include a robot within a robotic cell. The robot can define an end effector configured to grasp an object within a physical environment. The autonomous system can further include one or more processors, and a memory storing instructions that, when executed by the one or more processors, cause the autonomous system to retrieve a model of the object. The model can indicate one or more physical properties of the object. The autonomous system can further receive robot configuration data associated with the robotic cell, and obtain grasp point data associated with the object. Based on the robot configuration data, the one or more physical properties of the object, and the grasp point data, the autonomous system can select a path constraint for moving the object from a first location to a second location so as to define a selected path constraint. The selected path constraint can define a grasp pose for the robot to carry the object, a velocity associated with moving the object in the grasp pose, and an acceleration associated with moving the object in the grasp pose. The autonomous system can further be configured to extract, from the robot configuration data, a maximum velocity value and a maximum acceleration value at which the robot is designed to travel.

In some cases, at least one of the velocity of the selected path constraint and the acceleration of the selected path constraint is equivalent to the maximum velocity value and the maximum acceleration value, respectively. Alternatively, in some cases, the velocity of the selected path constraint is less than the maximum velocity value and the acceleration of the selected path constraint is less than the maximum acceleration value. The autonomous system can be further configured to determine a plurality of path constraints that define a plurality of grasp poses in which the robot can move the object from the first location to the second location without dropping the object, and to select the selected path constraint from the plurality of path constraints based on the velocity and acceleration of the selected path constraint. In some cases, to determine the path constraint, the autonomous system formulates and solves a constrain optimization problem based on the robot configuration data, the one or more physical properties of the object, and the grasp point data. In other examples, to determine the path constraint, the autonomous system simulates a plurality of trajectories based on the robot configuration data, the one or more physical properties of the object, and the grasp point data. Furthermore, to determine the path constraint, the autonomous system can assign a reward value to each of the plurality of trajectories based on velocity values, acceleration values, and grasp poses associated with the respective trajectories. After selecting the selected path constraint, the autonomous system, in particular the robot, can move the object from the first location to the second location in the grasp pose of the selected path constraint.

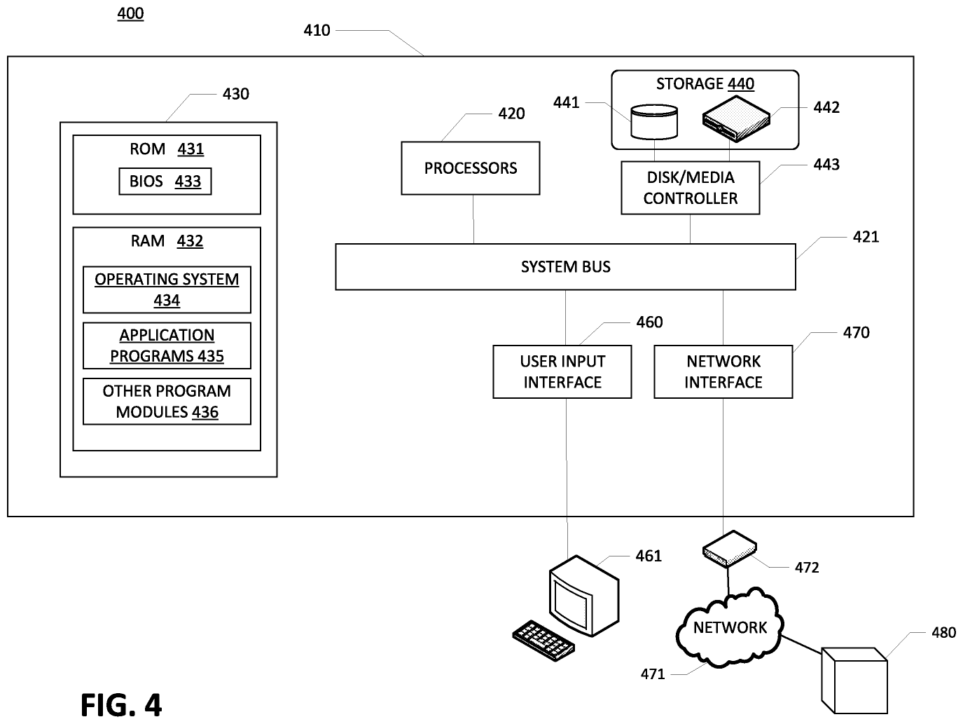

FIG. 4 illustrates an example of a computing environment within which embodiments of the present disclosure may be implemented. A computing environment 400 includes a computer system 410 that may include a communication mechanism such as a system bus 421 or other communication mechanism for communicating information within the computer system 410. The computer system 410 further includes one or more processors 420 coupled with the system bus 421 for processing the information. The autonomous system 102, the computing system 200, and the computing system 300 may include, or be coupled to, the one or more processors 420.

The processors 420 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 420 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 421 may include at least one of a system bus, a memory bus, an address bus, or a message bus, and may permit exchange of information (e.g., data (including computer-executable code), signaling, etc.) between various components of the computer system 410. The system bus 421 may include, without limitation, a memory bus or a memory controller, a peripheral bus, an accelerated graphics port, and so forth. The system bus 421 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 4, the computer system 410 may also include a system memory 430 coupled to the system bus 421 for storing information and instructions to be executed by processors 420. The system memory 430 may include computer readable storage media in the form of volatile and/or nonvolatile memory, such as read only memory (ROM) 431 and/or random access memory (RAM) 432. The RAM 432 may include other dynamic storage device(s) (e.g., dynamic RAM, static RAM, and synchronous DRAM). The ROM 431 may include other static storage device(s) (e.g., programmable ROM, erasable PROM, and electrically erasable PROM). In addition, the system memory 430 may be used for storing temporary variables or other intermediate information during the execution of instructions by the processors 420. A basic input/output system 433 (BIOS) containing the basic routines that help to transfer information between elements within computer system 410, such as during start-up, may be stored in the ROM 431. RAM 432 may contain data and/or program modules that are immediately accessible to and/or presently being operated on by the processors 420. System memory 430 may additionally include, for example, operating system 434, application programs 435, and other program modules 436. Application programs 435 may also include a user portal for development of the application program, allowing input parameters to be entered and modified as necessary.

The operating system 434 may be loaded into the memory 430 and may provide an interface between other application software executing on the computer system 410 and hardware resources of the computer system 410. More specifically, the operating system 434 may include a set of computer-executable instructions for managing hardware resources of the computer system 410 and for providing common services to other application programs (e.g., managing memory allocation among various application programs). In certain example embodiments, the operating system 434 may control execution of one or more of the program modules depicted as being stored in the data storage 440. The operating system 434 may include any operating system now known or which may be developed in the future including, but not limited to, any server operating system, any mainframe operating system, or any other proprietary or non-proprietary operating system.

The computer system 410 may also include a disk/media controller 443 coupled to the system bus 421 to control one or more storage devices for storing information and instructions, such as a magnetic hard disk 441 and/or a removable media drive 442 (e.g., floppy disk drive, compact disc drive, tape drive, flash drive, and/or solid state drive). Storage devices 440 may be added to the computer system 410 using an appropriate device interface (e.g., a small computer system interface (SCSI), integrated device electronics (IDE), Universal Serial Bus (USB), or FireWire). Storage devices 441, 442 may be external to the computer system 410.

The computer system 410 may also include a field device interface 465 coupled to the system bus 421 to control a field device 466, such as a device used in a production line. The computer system 410 may include a user input interface or GUI 461, which may comprise one or more input devices, such as a keyboard, touchscreen, tablet and/or a pointing device, for interacting with a computer user and providing information to the processors 420.

The computer system 410 may perform a portion or all of the processing steps of embodiments of the invention in response to the processors 420 executing one or more sequences of one or more instructions contained in a memory, such as the system memory 430. Such instructions may be read into the system memory 430 from another computer readable medium of storage 440, such as the magnetic hard disk 441 or the removable media drive 442. The magnetic hard disk 441 (or solid state drive) and/or removable media drive 442 may contain one or more data stores and data files used by embodiments of the present disclosure. The data store 440 may include, but are not limited to, databases (e.g., relational, object-oriented, etc.), file systems, flat files, distributed data stores in which data is stored on more than one node of a computer network, peer-to-peer network data stores, or the like. The data stores may store various types of data such as, for example, skill data, sensor data, or any other data generated in accordance with the embodiments of the disclosure. Data store contents and data files may be encrypted to improve security. The processors 420 may also be employed in a multi-processing arrangement to execute the one or more sequences of instructions contained in system memory 430. In alternative embodiments, hard-wired circuitry may be used in place of or in combination with software instructions. Thus, embodiments are not limited to any specific combination of hardware circuitry and software.

As stated above, the computer system 410 may include at least one computer readable medium or memory for holding instructions programmed according to embodiments of the invention and for containing data structures, tables, records, or other data described herein. The term “computer readable medium” as used herein refers to any medium that participates in providing instructions to the processors 420 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 441 or removable media drive 442. Non-limiting examples of volatile media include dynamic memory, such as system memory 430. Non-limiting examples of transmission media include coaxial cables, copper wire, and fiber optics, including the wires that make up the system bus 421. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 400 may further include the computer system 410 operating in a networked environment using logical connections to one or more remote computers, such as remote computing device 480. The network interface 470 may enable communication, for example, with other remote devices 480 or systems and/or the storage devices 441, 442 via the network 471. Remote computing device 480 may be a personal computer (laptop or desktop), a mobile device, a server, a router, a network PC, a peer device or other common network node, and typically includes many or all of the elements described above relative to computer system 410. When used in a networking environment, computer system 410 may include modem 472 for establishing communications over a network 471, such as the Internet. Modem 472 may be connected to system bus 421 via user network interface 470, or via another appropriate mechanism.

Network 471 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 410 and other computers (e.g., remote computing device 480). The network 471 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 471.

It should be appreciated that the program modules, applications, computer-executable instructions, code, or the like depicted in FIG. 4 as being stored in the system memory 430 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 410, the remote device 480, and/or hosted on other computing device(s) accessible via one or more of the network(s) 471, may be provided to support functionality provided by the program modules, applications, or computer-executable code depicted in FIG. 4 and/or additional or alternate functionality. Further, functionality may be modularized differently such that processing described as being supported collectively by the collection of program modules depicted in FIG. 4 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 4 may be implemented, at least partially, in hardware and/or firmware across any number of devices.

It should further be appreciated that the computer system 410 may include alternate and/or additional hardware, software, or firmware components beyond those described or depicted without departing from the scope of the disclosure. More particularly, it should be appreciated that software, firmware, or hardware components depicted as forming part of the computer system 410 are merely illustrative and that some components may not be present or additional components may be provided in various embodiments. While various illustrative program modules have been depicted and described as software modules stored in system memory 430, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A method of moving an object by a robot, the method comprising:
retrieving a model of the object, the model indicating one or more physical properties of the object;
receiving robot configuration data associated with the robotic cell;
obtaining grasp point data associated with the object; and
based on the robot configuration data, the one or more physical properties of the object, and the grasp point data, selecting a path constraint for moving the object from a first location to a second location so as to define a selected path constraint, the selected path constraint defining a grasp pose for the robot to carry the object, a velocity associated with moving the object in the grasp pose, and an acceleration associated with moving the object in the grasp pose.

2. The method as recited in claim 1, the method further comprising:
extracting, from the robot configuration data, a maximum velocity value and a maximum acceleration value at which the robot is designed to travel.

3. The method as recited in claim 2, wherein at least one of the velocity of the selected path constraint and the acceleration of the selected path constraint is equivalent to the maximum velocity value and the maximum acceleration value, respectively.

4. The method as recited in claim 3, wherein the velocity of the selected path constraint is less than the maximum velocity value and the acceleration of the selected path constraint is less than the maximum acceleration value.

5. The method as recited in claim 1, the method further comprising:
determining a plurality of path constraints that define a plurality of grasp poses in which the robot can move the object from the first location to the second location without dropping the object; and
selecting the selected path constraint from the plurality of path constraints based on the velocity and acceleration of the selected path constraint.

6. The method as recited in claim 5, wherein determining the plurality of path constraints further comprises:
based on the robot configuration data, the one or more physical properties of the object, and the grasp point data, formulating and solving a constraint optimization problem.

7. The method as recited in claim 5, wherein determining the plurality of path constraints further comprises:
based on the robot configuration data, the one or more physical properties of the object, and the grasp point data, simulating a plurality of trajectories; and
assigning a reward value to each of the plurality of trajectories based on velocity values, acceleration values, and grasp poses associated with the respective trajectories.

8. The method as recited in claim 1, the method further comprising:
moving the object, by the robot, from the first location to the second location in the grasp pose of the selected path constraint.

9. An autonomous system comprising:
a robot within a robotic cell, the robot defining an end effector configured to grasp an object within a physical environment;
one or more processors; and
a memory storing instructions that, when executed by the one or more processors, cause the autonomous system to:
retrieve a model of the object, the model indicating one or more physical properties of the object;
receive robot configuration data associated with the robotic cell;
obtain grasp point data associated with the object; and
based on the robot configuration data, the one or more physical properties of the object, and the grasp point data, select a path constraint for moving the object from a first location to a second location so as to define a selected path constraint, the selected path constraint defining a grasp pose for the robot to carry the object, a velocity associated with moving the object in the grasp pose, and an acceleration associated with moving the object in the grasp pose.

10. The autonomous system as recited in claim 9, the memory further storing instructions that, when executed by the one or more processors, further cause the autonomous system to:
extract, from the robot configuration data, a maximum velocity value and a maximum acceleration value at which the robot is designed to travel.

11. The autonomous system as recited in claim 10, wherein at least one of the velocity of the selected path constraint and the acceleration of the selected path constraint is equivalent to the maximum velocity value and the maximum acceleration value, respectively.

12. The autonomous system as recited in claim 11, wherein the velocity of the selected path constraint is less than the maximum velocity value and the acceleration of the selected path constraint is less than the maximum acceleration value.

13. The autonomous system as recited in claim 9, the memory further storing instructions that, when executed by the one or more processors, further cause the autonomous system to:
determine a plurality of path constraints that define a plurality of grasp poses in which the robot can move the object from the first location to the second location without dropping the object; and
select the selected path constraint from the plurality of path constraints based on the velocity and acceleration of the selected path constraint.

14. The autonomous system as recited in claim 13, the memory further storing instructions that, when executed by the one or more processors, further cause the autonomous system to:
based on the robot configuration data, the one or more physical properties of the object, and the grasp point data, formulate and solve a constraint optimization problem.

15. The autonomous system as recited in claim 1, the memory further storing instructions that, when executed by the one or more processors, further cause the autonomous system to:
based on the robot configuration data, the one or more physical properties of the object, and the grasp point data, simulating a plurality of trajectories; and
assign a reward value to each of the plurality of trajectories based on velocity values, acceleration values, and grasp poses associated with the respective trajectories.

16. The autonomous system as recited in claim 9, the memory further storing instructions that, when executed by the one or more processors, further cause the autonomous system to:
move the object, by the robot, from the first location to the second location in the grasp pose of the selected path constraint.

17. A non-transitory computer-readable storage medium including instructions that, when processed by a computing system cause the computing system to perform the method according to claim 1.
